(19) United States
(12) Patent Application Publication
(10) Pub. No.: US 2024/0218096 A1
(43) Pub. Date: Jul. 4, 2024

(54) FLUORINE-CONTAINING ORGANIC CHAIN GRAFTED POLYOXOMETALATE CLUSTER AND DERIVATIVE THEREOF, AND THEIR PREPARATION METHOD AND USE

(71) Applicant: Jilin University, Changchun City (CN)

(72) Inventors: Haolong LI, Changchun City (CN); Haibo HE, Changchun City (CN)

(21) Appl. No.: 18/364,146

(22) Filed: Aug. 2, 2023

(30) Foreign Application Priority Data
Dec. 21, 2022 (CN) 202211647445.X

(51) Int. Cl. C08F 14/26; C09K 23/00; H01M 8/1039; H01M 8/1081

(52) U.S. Cl. CPC C08F 14/26; C09K 23/007; H01M 8/1039; H01M 8/1081; H01M 2008/1095

(57) ABSTRACT

Provided are a fluorine-containing organic chain grafted polyoxometalate cluster and a derivative thereof, and their preparation method. A method for preparing a fluorine-containing organic chain grafted polyoxometalate cluster includes: mixing a fluoroalkyl trimethoxysilane, a lacunary polyoxometalate cluster, an acid solution and an organic solvent to obtain a first mixture; and subjecting the first mixture to substitution reaction to obtain the fluorine-containing organic chain grafted polyoxometalate cluster. Further, a fluorine-containing organic chain grafted polyoxometalate cluster prepared by the above method includes a lacunary polyoxometalate cluster and a fluorine-containing organic chain grafted onto the lacunary polyoxometalate cluster.

### CROSS REFERENCE TO RELATED APPLICATION

This application claims the benefit and priority of Chinese Patent Application No. 202211647445.X, entitled “Fluorine-containing organic chain grafted polyoxometalate cluster and derivative thereof, and their preparation method and use” filed with China National Intellectual Property Administration on Dec. 21, 2022, the disclosure of which is incorporated by reference herein in its entirety as part of the present application.

### TECHNICAL FIELD

The disclosure relates to the technical field of polyoxometalate cluster hybrid materials, in particular to a fluorine-containing organic chain grafted polyoxometalate cluster and a derivative thereof, and their preparation method and use.

### BACKGROUND ART

Polyoxometalate (POM) clusters are a class of inorganic metal oxide nanoclusters, and their rich surface chemical properties allows them to be functionalized by organic modifications, thereby generating organic-inorganic hybrids. POM clusters display strong Bronsted acidity, excellent catalytic activity, and high electrochemical stability. The POM clusters hybrids prepared by an organic covalent grafting method could combine the physical and chemical properties of POM clusters per se with the additional properties of the grafted organic components. The POM clusters hybrids functionalized by covalently grafting organic components have been widely used in many fields, such as surfactants, electrolyte materials, liquid crystal materials, catalytic materials, and electrode materials.

However, the grafted organic chains for synthesizing POM clusters hybrids are mainly focused on alkyl chains and derivatives thereof, which limits the structural and functional diversity of POM cluster hybrids to a certain extent.

### SUMMARY

The present disclosure aims to provide a fluorine-containing organic chain grafted polyoxometalate cluster and a derivative thereof, and their preparation method and use, which could enrich the structure and function of the organic chain grafted POM cluster hybrid.

In order to achieve the above object, the present disclosure provides the following technical solutions.

In the first aspect, the present disclosure provides a method for preparing a fluorine-containing organic chain grafted polyoxometalate cluster, comprising:
mixing a fluoroalkyl trimethoxysilane, a lacunary polyoxometalate cluster, an acid solution and an organic solvent to obtain a first mixture; and
subjecting the first mixture to substitution reaction to obtain the fluorine-containing organic chain grafted polyoxometalate cluster.

In some embodiments, the lacunary polyoxometalate cluster includes one selected from the group consisting of a Keggin-type polyoxometalate cluster and a Dawson-type polyoxometalate cluster.

In some embodiments, the Keggin-type polyoxometalate cluster includes one selected from the group consisting of a lacunary Keggin-type silicotungstic acid and a lacunary Keggin-type phosphotungstic acid, and the Dawson-type polyoxometalate cluster includes a lacunary Dawson-type phosphotungstic acid.

In some embodiments, the lacunary Keggin-type silicotungstic acid is K₈[SiW₁₁O₃₉]: the lacunary Keggin-type phosphotungstic acid is K₇[PW₁₁O₃₉]; and the lacunary Dawson-type phosphotungstic acid is K₁₀[P₂W₁₇O₆₁].

In some embodiments, a molar ratio of the fluoroalkyl trimethoxysilane to the lacunary polyoxometalate cluster is in a range of 2:(0.5-3); the acid solution is hydrochloric acid with a concentration of 1 mol/L; and a molar ratio of the lacunary polyoxometalate cluster to an acid in the acid solution is in a range of 1:(2-8).

In some embodiments, the substitution reaction is conducted at room temperature for 5 h to 10 h.

In the second aspect, the present disclosure provides a fluorine-containing organic chain grafted polyoxometalate cluster prepared by the method described in the above technical solutions, comprising a lacunary polyoxometalate cluster and a fluorine-containing organic chain grafted onto the lacunary polyoxometalate cluster.

In the third aspect, the present disclosure provides a method for preparing a fluorine-containing organic chain grafted polyoxometalate cluster derivative, comprising:
mixing the fluorine-containing organic chain grafted polyoxometalate cluster as described in the above technical solutions with a counter reagent to obtain a second mixture; and
subjecting the second mixture to replacement to obtain a fluorine-containing organic chain grafted polyoxometalate cluster derivative containing different counter ions.

In some embodiments, the counter reagent includes one selected from the group consisting of a hydrogen ion exchange resin, a sodium ion exchange resin, tetrabutylammonium bromide and dioctadecyldimethylammonium bromide.

In the fourth aspect, the present disclosure provides a fluorine-containing organic chain grafted polyoxometalate cluster derivative prepared by the method described in the above technical solutions, including an anionic cluster moiety and a counter cationic moiety, wherein the anionic cluster moiety includes the lacunary polyoxometalate cluster and the fluorine-containing organic chain grafted onto the lacunary polyoxometalate cluster; and the counter cationic moiety includes one selected from the group consisting of potassium ion, hydrogen ion, sodium ion, tetrabutylammonium bromide ion and dioctadecyldimethylammonium bromide ion.

In the fifth aspect, the present disclosure provides use of the fluorine-containing organic chain grafted polyoxometalate cluster as described in the above technical solutions or the fluorine-containing organic chain grafted polyoxometalate cluster derivative as described in the above technical solutions in the field of proton exchange membranes or surfactants.

The present disclosure provides a method for preparing a fluorine-containing organic chain grafted polyoxometalate cluster. In this method, the silicon-oxygen bond of the fluoroalkyl trimethoxysilane is hydrolyzed and broken under the action of the acid, and then bonded with the W—O bond at the gap of the lacunary polyoxometalate cluster to form a W—O—Si bond. Each gap of the lacunary polyoxometalate cluster is bonded with two silanes, and between the two silanes a Si—O—Si bond is formed, so as to achieve covalent grafting of fluorine-containing organic molecular chains onto the polyoxometalate cluster.

The polyoxometalate cluster has properties such as high proton conduction, catalytic activity, photoelectric activity, and drug activity. The fluorine-containing organic chains have excellent chemical stability, extremely low surface energy and high hydrophobicity, which endow them with good use in surfactants, and allow they exhibit excellent dispersibility and surface activity. Fluorine atoms have a strong ability to bind electrons, high electronegativity, and excellent electrochemical and optical properties. In the present disclosure, by changing the types of the polyoxometalate cluster, different polyoxometalate cluster hybrids grafted with a fluorine-containing organic chain could be obtained. The hybrids combine the unique advantages of the polyoxometalate cluster and the fluorine-containing organic chain, which could enrich the structure and function of the organic chain grafted polyoxometalate cluster hybrids, and expand their use in diverse fields such as catalysis, proton conduction, surfactants, and electrochemistry.

### BRIEF DESCRIPTION OF THE DRAWINGS

FIG. 1 shows a schematic diagram of the molecular structure of K₄[SiW₁₁O₃₉(SiC₂H₄(C₂F₄)ₙ)₂O].

FIG. 2 shows a schematic diagram of the molecular structure of K₆[P₂W₁₇O₆₁(SiC₂H₄(C₂F₄)ₙ)₂O].

FIG. 3 shows a Fourier transform infrared (FTIR) spectrum of K₄[SiW₁₁O₃₉(SiC₂H₄(C₂F₄)₄)₂O] prepared in Example 4.

FIG. 4 shows a FTIR spectrum of K₃[PW₁₁O₃₉(SiC₂H₄(C₂F₄)₄)₂O] prepared in Example 10.

FIG. 5 shows a FTIR spectrum of K₆[P₂W₁₇O₆₁(SiC₂H₄(C₂F₄)₄)₂O] prepared in Example 16.

FIG. 6 shows a matrix-assisted laser desorption/ionization time-of-flight (MALDI-TOF) mass spectrum of the fluorine-containing organic chain grafted polyoxometalate cluster prepared in Example 4.

FIG. 7 shows a MALDI-TOF mass spectrum of the fluorine-containing organic chain grafted polyoxometalate cluster prepared in Example 10.

FIG. 8 shows a MALDI-TOF mass spectrum of the fluorine-containing organic chain grafted polyoxometalate cluster prepared in Example 16.

### DETAILED DESCRIPTION

The present disclosure provides a method for preparing a fluorine-containing organic chain grafted polyoxometalate cluster, comprising:
mixing a fluoroalkyl trimethoxysilane, a lacunary polyoxometalate cluster, an acid solution and an organic solvent to obtain a first mixture; and
subjecting the first mixture to substitution reaction to obtain the fluorine-containing organic chain grafted polyoxometalate cluster.

In the present disclosure, unless otherwise specified, the materials or reagents required for preparation are commercially available products well-known to those skilled in the art.

In some embodiments of the present disclosure, the fluoroalkyl trimethoxysilane has a structural formula as shown in Formula 1:

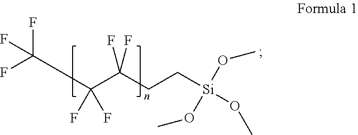

in which, n=1-20, preferably n=2-8, more preferably n=4-6.

In some embodiments, the lacunary polyoxometalate cluster includes one selected from the group consisting of a Keggin-type polyoxometalate cluster and a Dawson-type polyoxometalate cluster.

In some embodiments, the Keggin-type polyoxometalate cluster includes one selected from the group consisting of a lacunary Keggin-type silicotungstic acid and a lacunary Keggin-type phosphotungstic acid. In some embodiments, the lacunary Keggin-type silicotungstic acid is K₈[SiW₁₁O₃₉]. In some embodiments, the lacunary Keggin-type phosphotungstic acid is K₇[PW₁₁O₃₉].

In some embodiments, the Dawson-type polyoxometalate cluster includes a lacunary Dawson-type phosphotungstic acid. In some embodiments, the lacunary Dawson-type phosphotungstic acid is K₁₀[P₂W₁₇O₆₁].

In the present disclosures, there is no particular limitation on the specific source of the lacunary polyoxometalate cluster, and it may be prepared according to methods well-known in the art.

In some embodiments, a molar ratio of the fluoroalkyl trimethoxysilane to the lacunary polyoxometalate cluster is in a range of 2:(0.5-3), and preferably, 2.1:1.

In some embodiments, the acid solution is hydrochloric acid. In some embodiments, the acid solution has a concentration of 1 mol/L. In some embodiments, a molar ratio of the lacunary polyoxometalate cluster to an acid in the acid solution is in a range of 1:(2-8), and preferably 1:5. In the present disclosure, the acid solution is used to hydrolyze the silane, so that the fluoroalkyl trimethoxysilane and the lacunary polyoxometalate cluster undergo substitution reaction.

In some embodiments, the organic solvent includes acetonitrile, acetone, toluene, xylene, tetrahydrofuran or dichloroethane: in some embodiments, the organic solvent is acetonitrile. In the present disclosure, there is no particular limitation on the amount of the organic solvent, and it may be adjusted according to actual demands to ensure the reaction is performed smoothly.

In the present disclosure, there is no particular limitation on the specific process of mixing the fluoroalkyl trimethoxysilane, the lacunary polyoxometalate cluster, the acid solution and the organic solvent, and the materials may be uniformly mixed according to the process well-known in the art.

In some embodiments, the substitution reaction is conducted at room temperature. In some embodiments, the substitution reaction is conducted for 5 to 10 h, and preferably 8 h.

In some embodiments, after the substitution reaction is completed, the resulting product solution is filtered to obtain a clear solution, and the clear solution is then subjected to rotary-evaporation to remove the organic solvent, so as to obtain the fluorine-containing organic chain grafted polyoxometalate cluster. In some embodiments, the rotary-evaporation is carried out under a vacuum condition. In some embodiments, the rotary-evaporation is carried out at a temperature of 50° C. In the present disclosure, there is no particular limitation on the filtering, and a filtering process well-known in the art may be used.

Provided also is a fluorine-containing organic chain grafted polyoxometalate cluster prepared by the method as described in the above technical solutions, which includes a lacunary polyoxometalate cluster and a fluorine-containing organic chain grafted onto the lacunary polyoxometalate cluster.

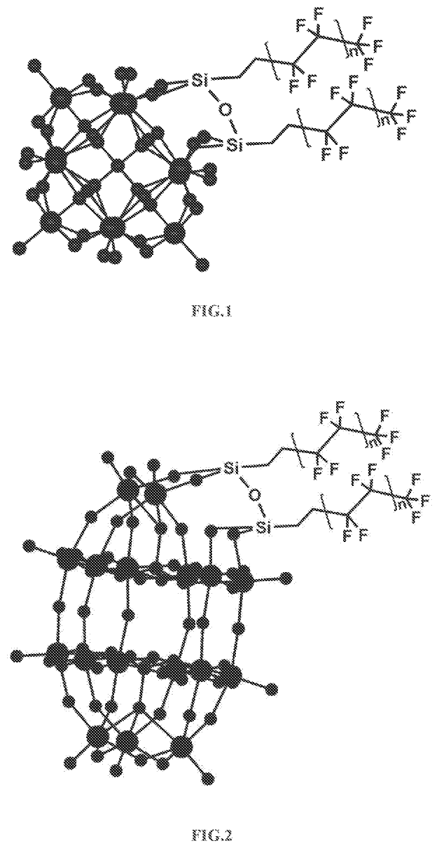

In some embodiments, a fluorine-containing organic chain grafted lacunary Keggin-type polyoxometalate cluster K₄[SiW₁₁O₃₉(SiC₂H₄(C₂F₄)ₙ)₂O] has a molecular structure as shown in FIG. 1.

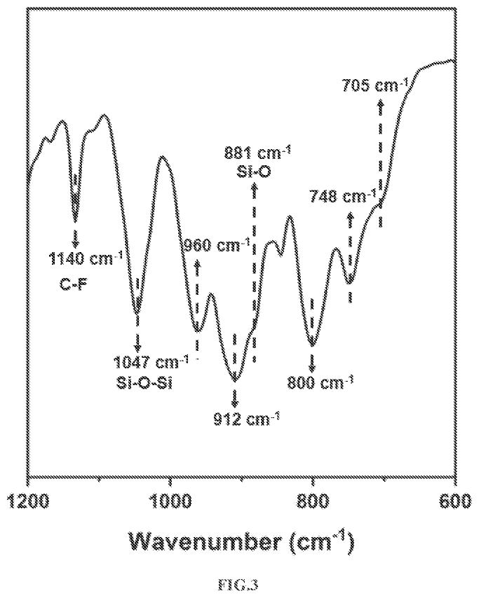

In some embodiments, a fluorine-containing organic chain grafted lacunary Dawson-type polyoxometalate cluster K₆[P₂W₁₇O₆₁(SiC₂H₄(C₂F₄)ₙ)₂O] has a molecular structure as shown in FIG. 2.

Provided further is a method for preparing a fluorine-containing organic chain grafted polyoxometalate cluster derivative, which comprises:
mixing the fluorine-containing organic chain grafted polyoxometalate cluster as described in the above technical solutions with a counter reagent to obtain a second mixture; and
subjecting the second mixture to replacement to obtain a fluorine-containing organic chain grafted polyoxometalate cluster derivative containing different counter ions,
wherein the counter reagent includes one selected from the group consisting of a hydrogen ion exchange resin, a sodium ion exchange resin, tetrabutylammonium bromide and dioctadecyldimethylammonium bromide.

In some embodiments, when the counter reagent is a hydrogen ion exchange resin or a sodium ion exchange resin, the hydrogen ion exchange resin or the sodium ion exchange resin is used as a stationary phase, and acetonitrile, acetone or toluene is used as a mobile phase: the fluorine-containing organic chain grafted polyoxometalate cluster is subjected to replacement to obtain hydrogen-type fluorine-containing organic chain grafted polyoxometalate cluster or sodium-type fluorine-containing organic chain grafted polyoxometalate cluster, respectively. During the replacement process, the counter ion K⁺ of the fluorine-containing organic chain grafted polyoxometalate cluster is replaced by H⁺ or Na⁺.

In the present disclosure, there is no particular limitation on the source and model of the hydrogen ion exchange resin or sodium ion exchange resin, and the corresponding resins well-known in the art may be used. In some embodiments, the model of the hydrogen ion exchange resin is Amberlite™ IRC 120H (purchased from Aladdin), and the model of the sodium ion exchange resin is Amberlite™ IR-120Na (purchased from Aladdin).

In some embodiments, the replacement is performed in a chromatographic column, and there is no special limitation on the chromatographic column, and the chromatographic column well-known in the art may be used.

In some embodiments, after the replacement is completed, the resulting clear solution is subjected to rotary-evaporation under a vacuum condition at 50° C. to remove the mobile phase, so that the hydrogen-type fluorine-containing organic chain grafted polyoxometalate cluster or sodium-type fluorine-containing organic chain grafted polyoxometalate cluster is obtained.

In some embodiments, when the counter reagent is tetrabutylammonium bromide (TBA) or dioctadecyldimethylammonium bromide (DODA) (the overall molecule solubility of the counter reagent is reduced, which could be precipitated out), the aqueous solution of TBA or DODA is added dropwise into the aqueous solution of the fluorine-containing organic chain grafted polyoxometalate cluster, and then a resulting mixture is filtered to obtain a TBA-type fluorine-containing organic chain grafted polyoxometalate cluster solid or a DODA-type fluorine-containing organic chain grafted polyoxometalate cluster solid. In the present disclosure, there is no special limitation on the concentrations of the aqueous solution of TBA or DODA and the aqueous solution of the fluorine-containing organic chain grafted polyoxometalate cluster, and they can be adjusted according to actual demands. There is no special limitation on the dropping and the filtering, and they may be carried out according to the processes well-known in the art.

In some embodiments, after the replacement is completed, water is removed from the resulting solid under a vacuum condition at 50° C., so that the TBA-type fluorine-containing organic chain grafted polyoxometalate cluster or DODA-type fluorine-containing organic chain grafted polyoxometalate cluster is obtained.

Provided further is a fluorine-containing organic chain grafted polyoxometalate cluster derivative prepared by the method described in the above technical solutions, which includes an anionic cluster moiety and a counter cationic moiety, wherein the anionic cluster moiety includes a lacunary polyoxometalate cluster and a fluorine-containing organic chain grafted onto the lacunary polyoxometalate cluster; and the counter cationic moiety includes one selected from the group consisting of potassium ion, hydrogen ion, sodium ion, tetrabutylammonium bromide ion and dioctadecyldimethylammonium bromide ion.

Provided further is use of the fluorine-containing organic chain grafted polyoxometalate cluster as described in the above technical solutions or the fluorine-containing organic chain grafted polyoxometalate cluster derivative as described in the above technical solutions in the field of proton exchange membranes or surfactants. In the present disclosure, there is no special limitation on the application method, and they could be applied according to methods well-known in the art.

In some embodiments, when the hydrogen-type fluorine-containing organic chain grafted polyoxometalate cluster is used in a proton exchange membrane, the hydrogen-type fluorine-containing organic chain grafted polyoxometalate cluster is mixed with a solution of a perfluorosulfonic acid membrane, and then the resulting mixture is cast to form a membrane to obtain a hydrogen-type fluorine-containing organic chain grafted polyoxometalate cluster hybrid perfluorosulfonic acid membrane, which is used in a proton exchange membrane in a fuel cell.

In some embodiments, the process for preparing the solution of the perfluorosulfonic acid membrane includes the following step:
drying a Nafion solution (commercially available, 20%, w/w) in a blast drying oven at 60° C. for 24 h to obtain a perfluorosulfonic acid membrane; and
dissolving the perfluorosulfonic acid membrane in N,N-dimethylacetamide (DMAc) by stirring to obtain the solution of the perfluorosulfonic acid membrane.

In some embodiments, the solution of the perfluorosulfonic acid membrane has a concentration of 0.05 g/mL to 0.10 g/mL, and preferably 0.06 g/mL to 0.08 g/mL.

In the present disclosure, there is no special limitation on the process of mixing the hydrogen-type fluorine-containing organic chain grafted polyoxometalate cluster and the solution of the perfluorosulfonic acid membrane, and it can be carried out according to processes well-known in the art.

In some embodiments, the casting to form a membrane is performed at a temperature of 25° C. to 180° C., and preferably 80° C.

In some embodiments, after the casting to form a membrane is completed, a result membrane is dried to obtain a hydrogen-type fluorine-containing organic chain grafted polyoxometalate cluster hybrid perfluorosulfonic acid membrane. In some embodiments, the drying is performed at a temperature of 60° C. to 80° C. In some embodiments, the drying is performed for 12 h.

In some embodiments, based on the mass of the perfluorosulfonic acid membrane, a hybrid mass percentage of the hydrogen-type fluorine-containing organic chain grafted polyoxometalate cluster in the perfluorosulfonic acid membrane is in a range of 1% to 20%, preferably 1% to 15%, and more preferably 1% to 5%. In some embodiments, the amounts of the hydrogen-type fluorine-containing organic chain grafted polyoxometalate cluster and the solution of the perfluorosulfonic acid membrane are controlled such that the above range could be achieved.

In some embodiments, the hydrogen-type fluorine-containing organic chain grafted polyoxometalate cluster hybrid perfluorosulfonic acid membrane has a thickness of 60 μm to 120 μm, and preferably 80 μm to 100 μm.

The technical solutions of the present disclosure will be clearly and completely described below in conjunction with the examples of the present disclosure. Obviously, the described examples are only a part of, not all of, the examples of the present disclosure. Based on the examples of the present disclosure, all other examples obtained by persons of ordinary skill in the art without making creative efforts shall fall within the scope of the present disclosure.

In the following examples, the lacunary polyoxometalate clusters used in the present disclosure were prepared with reference to the prior art (Weilin Chen and Enbo Wang, Polyacid Chemistry, published in July 2013, ISBN code: 9787030379368. The synthesis of K₈[SiW₁₁O₃₉] could be found on page 103: the synthesis of K₇[PW₁₁O₃₉] could be found on page 97; and the synthesis of K₁₀[P₂W₁₇O₆₁] could be found on page 178. The content of which is incorporated by reference herein).

The model of the hydrogen ion exchange resin used in the examples is Amberlite™ IRC 120H (purchased from Aladdin), and the model of the sodium ion exchange resin used in the examples is Amberlite™ IR-120Na (purchased from Aladdin).

### Example 1

1 mmol of a lacunary Keggin-type silicotungstic acid K₈[SiW₁₁O₃₉] was added into a round bottom flask, and then 5 mmol of HCl (1 mol/L), 50 mL of acetonitrile and 2.1 mmol of fluoroalkyl trimethoxysilane with a polymerization degree n of 2 were added thereto to obtain a mixture. The resulting mixture reacted at room temperature for 8 h. The resulting product was filtered to obtain a liquid, and then the liquid was subjected to rotary-evaporation under a vacuum condition at 50° C. to remove the acetonitrile, so as to obtain a fluorine-containing organic chain grafted Keggin-type silicotungstic acid K₄[SiW₁₁O₃₉(SiC₂H₄(C₂F₄)₂)₂O].

### Example 2

A fluorine-containing organic chain grafted Keggin-type silicotungstic acid K₄[SiW₁₁O₃₉(SiC₂H₄(C₂F₄)₂)₂O] was prepared according to the method described in Example 1.

A hydrogen ion exchange resin was added into a chromatographic column as a stationary phase, and acetonitrile was added thereto as a mobile phase. The fluorine-containing organic chain grafted Keggin-type silicotungstic acid was then subjected to replacement through the chromatographic column. A clear solution obtained from the replacement was subjected to rotary-evaporation under a vacuum condition at 50° C. to remove the acetonitrile, so as to obtain a solid of a hydrogen-type fluorine-containing organic chain grafted Keggin-type silicotungstic acid H₄[SiW₁₁O₃₉(SiC₂H₄(C₂F₄)₂)₂O].

### Example 3

A fluorine-containing organic chain grafted Keggin-type silicotungstic acid K₄[SiW₁₁O₃₉(SiC₂H₄(C₂F₄)₂)₂O] was prepared according to the method described in Example 1.

1 mmol of the fluorine-containing organic chain grafted Keggin-type silicotungstic acid K₄[SiW₁₁O₃₉(SiC₂H₄(C₂F₄)₂)₂O] was dissolved into 50 ml of water to form an aqueous solution of the fluorine-containing organic chain grafted Keggin-type silicotungstic acid. 7 mmol of tetrabutylammonium bromide was dissolved into 5 ml of water to form an aqueous solution of tetrabutylammonium bromide. The aqueous solution of tetrabutylammonium bromide was added dropwise into the aqueous solution of the fluorine-containing organic chain grafted Keggin-type silicotungstic acid to conduct replacement and then filtered. Water was removed from a solid obtained after filtration under a vacuum condition at 50° C. so as to obtain a TBA-type fluorine-containing organic chain grafted Keggin-type silicotungstic acid TBA₄[SiW₁₁O₃₉(SiC₂H₄(C₂F₄)₂)₂O].

### Example 4

1 mmol of a lacunary Keggin-type silicotungstic acid K₈[SiW₁₁O₃₉] was added into a round bottom flask, and then 5 mmol of HCl (1 mol/L), 50 mL of acetonitrile and 2.1 mmol of fluoroalkyl trimethoxysilane with a polymerization degree n of 4 were added thereto to obtain a mixture. The resulting mixture reacted at room temperature for 8 h. The resulting product was filtered to obtain a liquid, and then the liquid was subjected to rotary-evaporation under a vacuum condition at 50° C. to remove the acetonitrile solvent, so as to obtain a fluorine-containing organic chain grafted Keggin-type silicotungstic acid K₄[SiW₁₁O₃₉(SiC₂H₄(C₂F₄)₄)₂O].

### Example 5

A fluorine-containing organic chain grafted Keggin-type silicotungstic acid K₄[SiW₁₁O₃₉(SiC₂H₄(C₂F₄)₄)₂O] was prepared according to the method described in Example 4.

A hydrogen ion exchange resin was added into a chromatographic column as a stationary phase, and acetonitrile was added thereto as a mobile phase. The fluorine-containing organic chain grafted Keggin-type silicotungstic acid was then subjected to replacement through the chromatographic column. A clear solution obtained after the replacement was subjected to rotary-evaporation under a vacuum condition at 50° C. to remove the acetonitrile solvent, so as to obtain a solid of a hydrogen-type fluorine-containing organic chain grafted Keggin-type silicotungstic acid H₄[SiW₁₁O₃₉(SiC₂H₄(C₂F₄)₄)₂O].

### Example 6

A fluorine-containing organic chain grafted Keggin-type silicotungstic acid K₄[SiW₁₁O₃₉(SiC₂H₄(C₂F₄)₄)₂O] was prepared according to the method described in Example 4.

1 mmol of the fluorine-containing organic chain grafted Keggin-type silicotungstic acid K₄[SiW₁₁O₃₉(SiC₂H₄(C₂F₄)₄)₂O] was dissolved into 50 ml of water to form an aqueous solution of the fluorine-containing organic chain grafted Keggin-type silicotungstic acid. 7 mmol of tetrabutylammonium bromide was dissolved into 5 ml of water to form an aqueous solution of tetrabutylammonium bromide. The aqueous solution of tetrabutylammonium bromide was added dropwise into the aqueous solution of the fluorine-containing organic chain grafted Keggin-type silicotungstic acid to conduct replacement and then filtered. Water was removed from a solid obtained after filtration under a vacuum condition at 50° C. so as to obtain a TBA-type fluorine-containing organic chain grafted Keggin-type silicotungstic acid TBA₄[SiW₁₁O₃₉(SiC₂H₄(C₂F₄)₄)₂O].

### Example 7

1 mmol of a lacunary Keggin-type phosphotungstic acid K₇[PW₁₁O₃₉] was added into a round bottom flask, and then 5 mmol of HCl (1 mol/L), 50 mL of acetonitrile and 2.1 mmol of fluoroalkyl trimethoxysilane with a polymerization degree n of 2 were added thereto to obtain a mixture. The resulting mixture reacted at room temperature for 8 h. The resulting product was filtered to obtain a liquid, and then the liquid was subjected to rotary-evaporation under a vacuum condition at 50° C. to remove the acetonitrile solvent, so as to obtain a fluorine-containing organic chain grafted Keggin-type phosphotungstic acid K₃[PW₁₁O₃₉(SiC₂H₄(C₂F₄)₂)₂O].

### Example 8

A fluorine-containing organic chain grafted Keggin-type phosphotungstic acid K₃[PW₁₁O₃₉(SiC₂H₄(C₂F₄)₂)₂O] was prepared according to the method described in Example 7.

A hydrogen ion exchange resin was added into a chromatographic column as a stationary phase, and acetonitrile was added thereto as a mobile phase. The fluorine-containing organic chain grafted Keggin-type phosphotungstic acid was then subjected to replacement through the chromatographic column. A clear solution obtained from the replacement was subjected to rotary-evaporation under a vacuum condition at 50° C. to remove the acetonitrile solvent, so as to obtain a solid of a hydrogen-type fluorine-containing organic chain grafted Keggin-type phosphotungstic acid H₃[PW₁₁O₃₉(SiC₂H₄(C₂F₄)₂)₂O].

### Example 9

A fluorine-containing organic chain grafted Keggin-type phosphotungstic acid K₃[PW₁₁O₃₉(SiC₂H₄(C₂F₄)₂)₂O] was prepared according to the method described in Example 7.

1 mmol of the fluorine-containing organic chain grafted Keggin-type phosphotungstic acid K₃[PW₁₁O₃₉(SiC₂H₄(C₂F₄)₂)₂O] was dissolved into 50 ml of water to form an aqueous solution of the fluorine-containing organic chain grafted Keggin-type phosphotungstic acid. 7 mmol of tetrabutylammonium bromide was dissolved into 5 ml of water to form an aqueous solution of tetrabutylammonium bromide. The aqueous solution of tetrabutylammonium bromide was added dropwise into the aqueous solution of the fluorine-containing organic chain grafted Keggin-type phosphotungstic acid to conduct replacement and then filtered. Water was removed from a solid obtained after filtration under a vacuum condition at 50° C. so as to obtain a TBA-type fluorine-containing organic chain grafted Keggin-type phosphotungstic acid TBA₃[PW₁₁O₃₉(SiC₂H₄(C₂F₄)₂)₂O].

### Example 10

1 mmol of a lacunary Keggin-type phosphotungstic acid K₇[PW₁₁O₃₉] was added into a round bottom flask, and then 5 mmol of HCl (1 mol/L), 50 mL of acetonitrile and 2.1 mmol of fluoroalkyl trimethoxysilane with a polymerization degree n of 4 were added thereto to obtain a mixture. The resulting mixture reacted at room temperature for 8 h. The resulting product was filtered to obtain a liquid, and then the liquid was subjected to rotary-evaporation under a vacuum condition at 50° C. to remove the acetonitrile solvent, so as to obtain a fluorine-containing organic chain grafted Keggin-type phosphotungstic acid K₃[PW₁₁O₃₉(SiC₂H₄(C₂F₄)+)₂O].

### Example 11

A fluorine-containing organic chain grafted Keggin-type phosphotungstic acid K₃[PW₁₁O₃₉(SiC₂H₄(C₂F₄)₄)₂O] was prepared according to the method described in Example 10.

A hydrogen ion exchange resin was added into a chromatographic column as a stationary phase, and acetonitrile was added thereto as a mobile phase. The fluorine-containing organic chain grafted Keggin-type phosphotungstic acid was then subjected to replacement through the chromatographic column. A clear solution obtained after the replacement was subjected to rotary-evaporation under a vacuum condition at 50° C. to remove the acetonitrile solvent, so as to obtain a solid of a hydrogen-type fluorine-containing organic chain grafted Keggin-type phosphotungstic acid H₃[PW₁₁O₃₉(SiC₂H₄(C₂F₄)₄)₂O].

### Example 12

A fluorine-containing organic chain grafted Keggin-type phosphotungstic acid K₃[PW₁₁O₃₉(SiC₂H₄(C₂F₄)₄)₂O] was prepared according to the method described in Example 10.

1 mmol of the fluorine-containing organic chain grafted Keggin-type phosphotungstic acid K₃[PW₁₁O₃₉(SiC₂H₄(C₂F₄)₄)₂O] was dissolved into 50 ml of water to form an aqueous solution of the fluorine-containing organic chain grafted Keggin-type phosphotungstic acid. 7 mmol of tetrabutylammonium bromide was dissolved into 5 ml of water to form an aqueous solution of tetrabutylammonium bromide. The aqueous solution of tetrabutylammonium bromide was added dropwise into the aqueous solution of the fluorine-containing organic chain grafted Keggin-type phosphotungstic acid to conduct replacement and then filtered. Water was removed from a solid obtained after filtration under a vacuum condition at 50° C. so as to obtain a TBA-type fluorine-containing organic chain grafted Keggin-type phosphotungstic acid TBA₃[PW₁₁O₃₉(SiC₂H₄(C₂F₄)₄)₂O].

### Example 13

1 mmol of a lacunary Dawson-type phosphotungstic acid K₁₀[P₂W₁₇O₆₁] was added into a round bottom flask, and then 5 mmol of HCl (1 mol/L), 50 mL of acetonitrile and 2.1 mmol of fluoroalkyl trimethoxysilane with a polymerization degree n of 2 were added thereto to obtain a mixture. The resulting mixture reacted at room temperature for 8 h. The resulting product was filtered to obtain a liquid, and then the liquid was subjected to rotary-evaporation under a vacuum condition at 50° C. to remove the acetonitrile solvent, so as to obtain a fluorine-containing organic chain grafted Dawson-type phosphotungstic acid K₆[P₂W₁₇O₆₁(SiC₂H₄(C₂F₄)₂)₂O].

### Example 14

A fluorine-containing organic chain grafted Dawson-type phosphotungstic acid K₆[P₂W₁₇O₆₁(SiC₂H₄(C₂F₄)₂)₂O] was prepared according to the method described in Example 13.

A hydrogen ion exchange resin was added into a chromatographic column as a stationary phase, and acetonitrile was added thereto as a mobile phase. The fluorine-containing organic chain grafted Dawson-type phosphotungstic acid was then subjected to replacement through the chromatographic column. A clear solution obtained from the replacement was subjected to rotary-evaporation under a vacuum condition at 50° C. to remove the acetonitrile solvent, so as to obtain a solid of a hydrogen-type fluorine-containing organic chain grafted Dawson-type phosphotungstic acid H₆[P₂W 17061(SiC₂H₄(C₂F₄)₂)₂O].

### Example 15

A fluorine-containing organic chain grafted Dawson-type phosphotungstic acid K₆[P₂W₁₇O₆₁(SiC₂H₄(C₂F₄)₂)₂O] was prepared according to the method described in Example 13.

1 mmol of the fluorine-containing organic chain grafted Dawson-type phosphotungstic acid K₆[P₂W₁₇O₆₁(SiC₂H₄(C₂F₄)₂)₂O] was dissolved into 50 ml of water to form an aqueous solution of the fluorine-containing organic chain grafted Dawson-type phosphotungstic acid. 7 mmol of tetrabutylammonium bromide was dissolved into 5 ml of water to form an aqueous solution of tetrabutylammonium bromide. The aqueous solution of tetrabutylammonium bromide was added dropwise into the aqueous solution of the fluorine-containing organic chain grafted Dawson-type phosphotungstic acid to conduct replacement and then filtered. Water was removed from a solid obtained after filtration under a vacuum condition at 50° C. so as to obtain a TBA-type fluorine-containing organic chain grafted Dawson-type phosphotungstic acid TBA₆[P₂W 17061(SiC₂H₄(C₂F₄)₂)₂O].

### Example 16

1 mmol of a lacunary Dawson-type phosphotungstic acid K₁₀[P₂W₁₇O₆₁] was added into a round bottom flask, and then 5 mmol of HCl (1 mol/L), 50 mL of acetonitrile and 2.1 mmol of fluoroalkyl trimethoxysilane with a polymerization degree n of 4 were added thereto to obtain a mixture. The resulting mixture reacted at room temperature for 8 h. The resulting product was filtered to obtain a liquid, and then the liquid was subjected to rotary-evaporation under a vacuum condition at 50° C. to remove the acetonitrile solvent, so as to obtain a fluorine-containing organic chain grafted Dawson-type phosphotungstic acid K₆[P₂W₁₇O₆₁(SiC₂H₄(C₂F₄)₄)₂O].

### Example 17

A fluorine-containing organic chain grafted Dawson-type phosphotungstic acid K₆[P₂W₁₇O₆₁(SiC₂H₄(C₂F₄)₄)₂O] was prepared according to the method described in Example 16.

A hydrogen ion exchange resin was added into a chromatographic column as a stationary phase, and acetonitrile was added thereto as a mobile phase. The fluorine-containing organic chain grafted Dawson-type phosphotungstic acid was then subjected to replacement through the chromatographic column. A clear solution obtained from the replacement was subjected to rotary-evaporation under a vacuum condition at 50° C. to remove the acetonitrile solvent, so as to obtain a solid of a hydrogen-type fluorine-containing organic chain grafted Dawson-type phosphotungstic acid H₆[P₂W 17061(SiC₂H₄(C₂F₄)₄)₂O].

### Example 18

A fluorine-containing organic chain grafted Dawson-type phosphotungstic acid K₆[P₂W₁₇O₆₁(SiC₂H₄(C₂F₄)₄)₂O] was prepared according to the method described in Example 16.

1 mmol of the fluorine-containing organic chain grafted Dawson-type phosphotungstic acid K₆[P₂W₁₇O₆₁(SiC₂H₄(C₂F₄)₄)₂O] was dissolved into 50 ml of water to form an aqueous solution of the fluorine-containing organic chain grafted Dawson-type phosphotungstic acid. 7 mmol of tetrabutylammonium bromide was dissolved into 5 ml of water to form an aqueous solution of tetrabutylammonium bromide. The aqueous solution of tetrabutylammonium bromide was added dropwise into the aqueous solution of the fluorine-containing organic chain grafted Dawson-type phosphotungstic acid to conduct replacement and then filtered. Water was removed from a solid obtained after filtration under a vacuum condition at 50° C. so as to obtain a TBA-type fluorine-containing organic chain grafted Dawson-type phosphotungstic acid TBA₆[P₂W 17061(SiC₂H₄(C₂F₄)₄)₂O].

### Use Example 1

0.1 g of Nafion membrane was dissolved in 1.5 ml of dimethylacetamide (DMAc) by stirring, and then 5 mg of the hydrogen-type fluorine-containing organic chain grafted Keggin-type silicotungstic acid as prepared in Example 5 was dissolved therein by stirring. The resulting mixture solution was cast to form a membrane at 80° C., and the membrane was dried at 80° C. for 12 h to obtain a hydrogen-type fluorine-containing organic chain grafted Keggin-type silicotungstic acid hybrid perfluorosulfonic acid membrane, with a membrane thickness of 80±3 μm, in which the mass percentage of the hydrogen-type fluorine-containing organic chain grafted Keggin-type silicotungstic acid is 5%.

### Use Example 2

0.1 g of Nafion membrane was dissolved in 1.5 ml of dimethylacetamide (DMAc) by stirring, and then 5 mg of the hydrogen-type fluorine-containing organic chain grafted Keggin-type phosphotungstic acid as prepared in Example 11 was dissolved therein by stirring. The resulting mixture solution was cast to form a membrane at 80° C., and the membrane was dried at 80° C. for 12 h to obtain a hydrogen-type fluorine-containing organic chain grafted Keggin-type phosphotungstic acid hybrid perfluorosulfonic acid membrane, with a membrane thickness of 80±3 μm, in which the mass percentage of the hydrogen-type fluorine-containing organic chain grafted Keggin-type phosphotungstic acid is 5%.

### Use Example 3

0.1 g of Nafion membrane was dissolved in 1.5 ml of dimethylacetamide (DMAc) by stirring, and then 5 mg of the hydrogen-type fluorine-containing organic chain grafted Dawson-type phosphotungstic acid as prepared in Example 17 was dissolved therein by stirring. The resulting mixture solution was cast to form a membrane at 80° C., and the membrane was dried at 80° C. for 12 h to obtain a hydrogen-type fluorine-containing organic chain grafted Dawson-type phosphotungstic acid hybrid perfluorosulfonic acid membrane, with a membrane thickness of 80±3 μm, in which the mass percentage of the hydrogen-type fluorine-containing organic chain grafted Dawson-type phosphotungstic acid is 5%.

### Comparative Use Example 1

0.1 g of Nafion membrane was dissolved in 1.5 ml of dimethylacetamide (DMAc) by stirring, and a resulting solution was cast to form a membrane at 80° C., and the membrane was dried at 80° C. for 12 h to obtain a pure perfluorosulfonic acid membrane with a membrane thickness of 80±3 μm.

### Characterization and Performance Test

1) FIG. 3 shows the FTIR spectrum of K₄[SiW₁₁O₃₉(SiC₂H₄(C₂F₄)₄)₂O] prepared in Example 4. From FIG. 3, it can be seen that the absorption peaks of Si—O—Si bond at 1047 cm⁻¹, the absorption peak of the C—F bond of the fluorine-containing organic chain at 1140 cm⁻¹, and the absorption peaks of the Si—O bond and W—O bond of the polyoxometalate cluster appear simultaneously, proving successful synthesis of K₄[SiW₁₁O₃₉(SiC₂H₄(C₂F₄)₄)₂O].

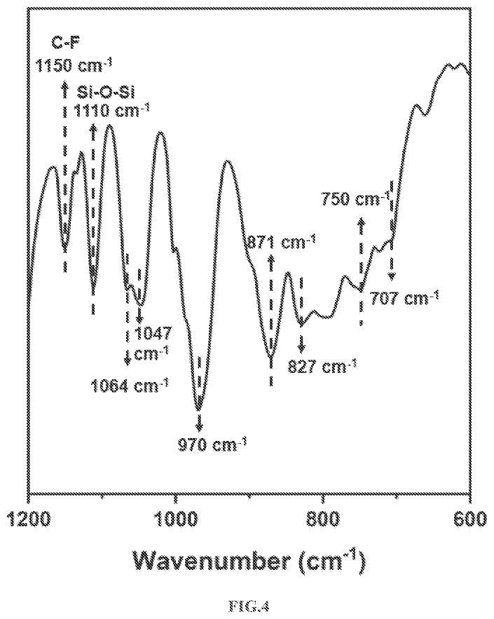

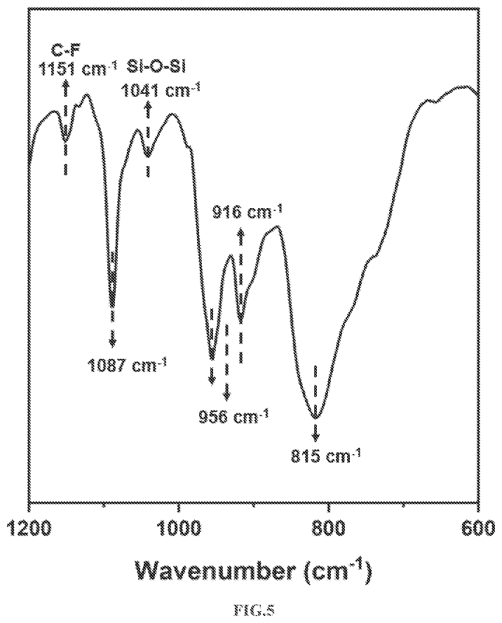

FIG. 4 shows the FTIR spectrum of K₃[PW₁₁O₃₉(SiC₂H₄(C₂F₄)₄)₂O] prepared in Example 10. From FIG. 4, it can be seen that the absorption peaks of Si—O—Si bond at 1110 cm⁻¹, the absorption peak of the C—F bond of the fluorine-containing organic chain at 1150 cm⁻¹, and the absorption peaks of the P—O bond and W—O bond of the polyoxometalate cluster appear simultaneously, proving successful synthesis of K₃[PW₁₁O₃₉(SiC₂H₄(C₂F₄)₄)₂O].

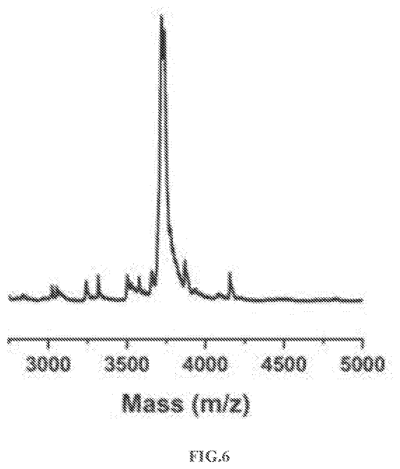

FIG. 5 shows the FTIR spectrum of K₆[P₂W 17061(SiC₂H₄(C₂F₄)₄)₂O] prepared in Example 16. From FIG. 5, it can be seen that the absorption peaks of Si—O—Si bond at 1110 cm⁻¹, the absorption peak of the C—F bond of the fluorine-containing organic chain at 1150 cm⁻¹, and the absorption peaks of the P—O bond and W—O bond of the polyoxometalate cluster appear simultaneously, proving successful synthesis of K₆[P₂W₁₇O₆₁(SiC₂H₄(C₂F₄)₄)₂O].

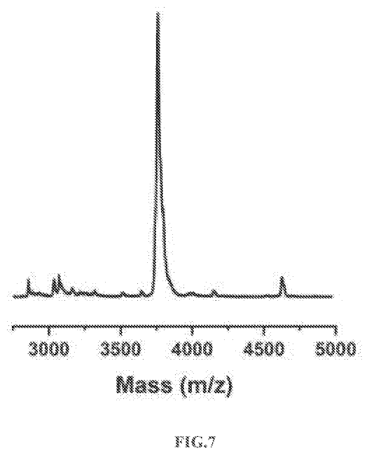

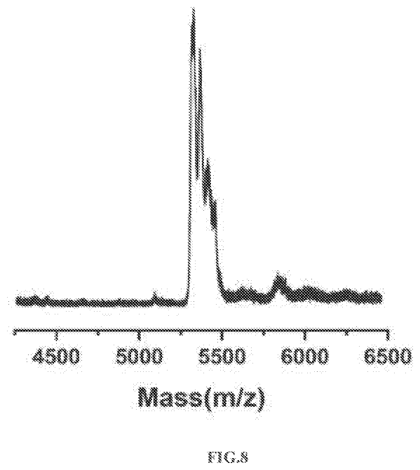

FIGS. 6 to 8 show the MALDI-TOF mass spectra of the fluorine-containing organic chain grafted polyoxometalate cluster prepared in Examples 4, 10 and 16, respectively. From FIGS. 6 to 8, it can be seen that the fluorine-containing organic chain grafted polyoxometalate cluster prepared in Examples 4, 10 and 16 have a molecular weight of 3759, 3722 and 5326 respectively, proving that the fluorine-containing organic chain grafted polyoxometalate cluster in Examples 4, 10 and 16 are successfully synthesized.

2) The hydrogen-type fluorine-containing organic chain grafted polyoxometalate cluster hybrid perfluorosulfonic acid membrane prepared in Use Examples 1 to 3 and the perfluorosulfonic acid membrane not hybridized by a hydrogen-type fluorine-containing organic chain grafted polyoxometalate cluster prepared in Comparative Use Example 1 were subjected to a conductivity measurement by using an alternating current impedance meter. Specifically, all the membranes were soaked in deionized water at 30° C. or 80° C. for 24 h, the conductivity was measured in the fully wet state of the water. The results are shown in Table 1.

TABLE 1
Proton conductivity of the sample membranes prepared
in Use Examples 1 to 3 and Comparative Use Example 1

| | 30° C. | 80° C. |
|---|---|---|
| Examples | (mS cm⁻¹) | (mS cm⁻¹) |
| Use Example 1 | 138 | 279 |
| Use Example 2 | 133 | 258 |
| Use Example 3 | 156 | 282 |
| Comparative Use Example 1 | 91 | 189 |

From Table 1, it can be seen that: all the hydrogen-type fluorine-containing organic chain grafted polyoxometalate cluster hybrid perfluorosulfonic acid membranes prepared in Use Examples 1 to 3 exhibit higher proton conductivity than that of pure perfluorosulfonic acid membranes, proving that a hybrid proton exchange membrane with high proton conductivity could be obtained by the method of the present disclosure, and it could be used in the field of proton exchange membrane in a fuel cell. In the present disclosure, by utilizing the high polarity characteristic of the fluorine-containing organic chain, the fluorine-containing organic chain is combined with the fluorine-containing segment of the perfluorosulfonic acid membrane, so that the fluorine-containing organic chain of the fluorine-containing organic chain covalently-grafted polyoxometalate cluster is inserted into the fluorine-containing phase region of the perfluorosulfonic acid membrane, resulting in that the prepared hybrid perfluorosulfonic acid membrane is immobilized with polyoxometalate cluster; meanwhile, hydrogen bonds are formed between the oxygen-rich surface of polyoxometalate cluster and the sulfonic acid groups of the perfluorosulfonic acid membrane, and the hydrogen bonds function as a proton hopping site to promote proton conduction. Based on the above, a hybrid proton exchange membrane with high proton conductivity has been obtained.

The above description is only preferred embodiments of the present disclosure. It should be noted that, without departing from the principle of the present disclosure, some improvements and modifications may be made by those skilled in the art, and such improvements and modifications should also be considered to fall within the scope of the present disclosure.

What is claimed is:

1. A method for preparing a fluorine-containing organic chain grafted polyoxometalate cluster, comprising:
mixing a fluoroalkyl trimethoxysilane, a lacunary polyoxometalate cluster, an acid solution and an organic solvent to obtain a first mixture; and
subjecting the first mixture to substitution reaction to obtain the fluorine-containing organic chain grafted polyoxometalate cluster.

2. The method according to claim 1, wherein the lacunary polyoxometalate cluster comprises one selected from the group consisting of a Keggin-type polyoxometalate cluster and a Dawson-type polyoxometalate cluster.

3. The method according to claim 2, wherein the Keggin-type polyoxometalate cluster comprises one selected from the group consisting of a lacunary Keggin-type silicotungstic acid and a lacunary Keggin-type phosphotungstic acid; and
the Dawson-type polyoxometalate cluster comprises a lacunary Dawson-type phosphotungstic acid.

4. The method according to claim 3, wherein the lacunary Keggin-type silicotungstic acid is K₈[SiW₁₁O₃₉];
the lacunary Keggin-type phosphotungstic acid is K₇[PW₁₁O₃₉]; and
the lacunary Dawson-type phosphotungstic acid is K₁₀[P₂W₁₇O₆₁].

5. The method according to claim 1, wherein a molar ratio of the fluoroalkyl trimethoxysilane to the lacunary polyoxometalate cluster is in a range of 2:(0.5-3);
the acid solution is hydrochloric acid with a concentration of 1 mol/L; and
a molar ratio of the lacunary polyoxometalate cluster to an acid in the acid solution is in a range of 1:(2-8).

6. The method according to claim 1, wherein the substitution reaction is conducted at room temperature for 5 h to 10 h.

7. A fluorine-containing organic chain grafted polyoxometalate cluster prepared by the method according to claim 1, comprising a lacunary polyoxometalate cluster and a fluorine-containing organic chain grafted onto the lacunary polyoxometalate cluster.

8. A method for preparing a fluorine-containing organic chain grafted polyoxometalate cluster derivative, comprising steps of:
mixing the fluorine-containing organic chain grafted polyoxometalate cluster according to claim 7 with a counter reagent to obtain a second mixture; and
subjecting the second mixture to replacement to obtain a fluorine-containing organic chain grafted polyoxometalate cluster derivative containing different counter ions:
wherein the counter reagent comprises one selected from the group consisting of a hydrogen ion exchange resin, a sodium ion exchange resin, tetrabutylammonium bromide and dioctadecyldimethylammonium bromide.

9. A fluorine-containing organic chain grafted polyoxometalate cluster derivative prepared by the method according to claim 8, comprising an anionic cluster moiety and a counter cationic moiety,
wherein the anionic cluster moiety comprises a lacunary polyoxometalate cluster and a fluorine-containing organic chain grafted onto the lacunary polyoxometalate cluster; and
the counter cationic moiety comprises one selected from the group consisting of potassium ion, hydrogen ion, sodium ion, tetrabutylammonium bromide ion and dioctadecyldimethylammonium bromide ion.

10. A method for preparing a proton exchange membrane or a surfactant, comprising using the fluorine-containing organic chain grafted polyoxometalate cluster according to claim 7.

11. A method for preparing a proton exchange membrane or a surfactant, comprising using the fluorine-containing organic chain grafted polyoxometalate cluster derivative according to claim 9.

12. The method according to claim 2, wherein a molar ratio of the fluoroalkyl trimethoxysilane to the lacunary polyoxometalate cluster is in a range of 2:(0.5-3);
the acid solution is hydrochloric acid with a concentration of 1 mol/L; and
a molar ratio of the lacunary polyoxometalate cluster to an acid in the acid solution is in a range of 1:(2-8).

13. The method according to claim 3, wherein a molar ratio of the fluoroalkyl trimethoxysilane to the lacunary polyoxometalate cluster is in a range of 2:(0.5-3);
the acid solution is hydrochloric acid with a concentration of 1 mol/L; and
a molar ratio of the lacunary polyoxometalate cluster to an acid in the acid solution is in a range of 1:(2-8).

14. The method according to claim 4, wherein a molar ratio of the fluoroalkyl trimethoxysilane to the lacunary polyoxometalate cluster is in a range of 2:(0.5-3);
the acid solution is hydrochloric acid with a concentration of 1 mol/L; and
a molar ratio of the lacunary polyoxometalate cluster to an acid in the acid solution is in a range of 1:(2-8).

15. The fluorine-containing organic chain grafted polyoxometalate cluster according to claim 7, wherein the lacunary polyoxometalate cluster comprises one selected from the group consisting of a Keggin-type polyoxometalate cluster and a Dawson-type polyoxometalate cluster.

16. The fluorine-containing organic chain grafted polyoxometalate cluster according to claim 7, wherein the Keggin-type polyoxometalate cluster comprises one selected from the group consisting of a lacunary Keggin-type silicotungstic acid and a lacunary Keggin-type phosphotungstic acid; and
the Dawson-type polyoxometalate cluster comprises a lacunary Dawson-type phosphotungstic acid.

17. The fluorine-containing organic chain grafted polyoxometalate cluster according to claim 7, wherein the lacunary Keggin-type silicotungstic acid is K₈[SiW₁₁O₃₉];
the lacunary Keggin-type phosphotungstic acid is K₇[PW₁₁O₃₉]; and
the lacunary Dawson-type phosphotungstic acid is K₁₀[P₂W₁₇O₆₁].

18. The fluorine-containing organic chain grafted polyoxometalate cluster according to claim 7, wherein a molar ratio of the fluoroalkyl trimethoxysilane to the lacunary polyoxometalate cluster is in a range of 2:(0.5-3);
the acid solution is hydrochloric acid with a concentration of 1 mol/L; and
a molar ratio of the lacunary polyoxometalate cluster to an acid in the acid solution is in a range of 1:(2-8).

19. The fluorine-containing organic chain grafted polyoxometalate cluster according to claim 7, wherein the substitution reaction is conducted at room temperature for 5 h to 10 h.
